(19) United States
(12) Patent Application Publication
(10) Pub. No.: US 2018/0038890 A1
(43) Pub. Date: Feb. 8, 2018

(54) OPTICALLY ENABLED MEMS INERTIAL SENSORS ON INTEGRATED PHOTONIC PLATFORMS

(71) Applicant: Khalifa University of Science and Technology

(72) Inventors: Marcus S. Dahlem, S.M. Feira (PT); Evgenii Demidov, Petrozavodsk (RU); Anatol Khilo, Abu Dhabi (AE)

(21) Appl. No.: 15/670,281

(22) Filed: Aug. 7, 2017

Related U.S. Application Data
(60) Provisional application No. 62/371,860, filed on Aug. 8, 2016.

(51) Int. Cl. G01P 15/13; G01C 19/56; G01P 15/097

(52) U.S. Cl. CPC G01P 15/131; G01P 15/097; G01C 19/56

(57) ABSTRACT

A method of forming a photonic inertial sensor includes providing a substrate having an insulation layer and a silicon layer on the insulation layer opposite the substrate; etching the silicon layer to form a silicon proof mass for the photonic inertial sensor; etching at least a portion of the insulation layer underneath the silicon proof mass to suspend the silicon proof mass; and depositing a high-density mass-increasing layer on the silicon proof mass to thereby increase the mass of the silicon proof mass.

### RELATED APPLICATIONS

This application claims priority to U.S. Provisional Application Ser. No. 62/371,860, filed Aug. 8, 2016, the disclosure of which is hereby incorporated by reference in its entirety.

### FIELD OF THE INVENTION

The present invention relates to photonic inertial sensors, and in particular, to photonic inertial sensors built on silicon-on-insulator platforms.

### BACKGROUND

Electronic products increasingly use motion-based sensing and control to improve interaction between users and their devices. Motion-based control is a fast growing integration aspect in modern portable devices. Having a sensing apparatus able to detect motion, acceleration or angular velocity introduces numerous applications that bring closer interaction between hardware and software functions.

MEMS (Micro-Electro Mechanical System) based accelerometers are devices that measure actual acceleration. MEMS accelerometer subsystems provide accurate detection while measuring acceleration, tilt, shock, and vibration in performance-driven applications. These systems are used in a wide variety of applications that include mobile devices, gaming systems, disk drive protection, image stabilization, sports and health devices, and military technologies.

Unlike traditional MEMS accelerometers, where the acceleration data is mapped into an electrical signal, optical MEMS accelerometers map the acceleration information directly into the optical domain. This allows seamless integration with photonic integrated circuits (PICs) and larger optical networks.

Most PICs are based on silicon-on-insulator (SOI) platforms, where a top thin silicon layer (normally from 50 nm to 340 nm) serves as the guiding layer for the optical signals. This silicon layer is also used for building electronic devices, which now allows for fully electronic-photonic integrated circuits (EPICs). The possibility of using this same top silicon layer for building MEMS accelerometers adds a significant advantage towards full integration of electronics, photonics and MEMS on a cost-effective platform. However, the major limitation of defining an accelerometer on the top silicon layer is related to the low proof mass.

Optical MEMS accelerometers are typically based on one of two working principles: intensity modulation or resonant wavelength change. Both of these devices have advantages over conventional MEMS accelerometers, such as immunity to electromagnetic radiation, low power consumption, and higher signal-to-noise ratio (SNR). In addition, both types of devices enable all-optical integration with photonic integrated circuits. Resonant wavelength change accelerometers provide greater sensitivity and resolution, but are usually more complex to design and fabricate. Furthermore, these accelerometers require a tunable element for wavelength scanning (either the laser source, a spectrum analyzer, or another tuning element). In contrast, intensity modulation accelerometers have lower sensitivity, but do not require a tunable element, which makes the device cheaper.

### SUMMARY OF EMBODIMENTS OF THE INVENTION

In some embodiments, a method of forming a photonic inertial sensor includes providing a substrate (for example, silicon) having an insulation layer (for example, an oxide) and a silicon layer (or any other low optical loss material with a refractive index higher than the insulation layer) on the insulation layer opposite the substrate; etching the top silicon layer to form a silicon proof mass for the photonic inertial sensor; etching at least a portion of the insulation layer underneath the silicon proof mass to suspend the silicon proof mass; and depositing a mass-increasing layer on top of the silicon proof mass to thereby increase the mass of the silicon proof mass.

In some embodiments, the mass-increasing layer comprises metal, such as aluminum.

In some embodiments, depositing a mass-increasing layer on the silicon proof mass comprises focused ion beam (FIB)-assisted deposition.

In some embodiments, etching the top silicon layer to form a silicon proof mass for the photonic inertial sensor comprises forming a silicon proof mass comprising voids therein.

In some embodiments, the method includes forming support springs that support the silicon proof mass when the silicon proof mass is suspended.

In some embodiments, the support springs comprise silicon from the top silicon layer and wherein etching the silicon layer to form a silicon proof mass further comprises etching the silicon layer to form the support springs.

In some embodiments, the method includes forming one or more waveguides on the top silicon layer, the one or more waveguides being physically coupled to the silicon proof mass such that movement of the silicon proof mass changes an optical output of the one or more waveguides. In some embodiments, movement of the silicon proof mass changes the intensity of light in the one or more waveguides. In some embodiments, movement of the silicon proof mass changes the resonant wavelength of a micro-ring or micro-disk resonator formed by one or more waveguides. In some embodiments, the one or more waveguides comprise two waveguides having evanescent-wave coupling therebetween. In some embodiments, the one or more waveguides comprise a photonic micro-ring or micro-disk resonator having an inner ring waveguide and an outer ring waveguide.

In some embodiments, a micro-opto-mechanical sensor device comprises a substrate; a silicon proof mass on the substrate and supported by a plurality of support springs, the silicon proof mass being spaced apart from the substrate; and one or more optical waveguides associated with the silicon proof mass such that movement of the silicon proof mass changes an optical output of the one or more optical waveguides, wherein the silicon proof mass comprises a silicon layer and a mass-increasing layer thereon.

In some embodiments, the mass-increasing layer comprises metal such as aluminum.

In some embodiments, the silicon proof mass comprises voids therein.

In some embodiments, the support springs each have first and second ends, the support springs being connected to the silicon proof mass at the first end and connected to an insulating layer at the second end. In some embodiments, the support springs comprise silicon.

In some embodiments, movement of the silicon proof mass changes an intensity of light in one or more waveguides. In some embodiments, movement of the silicon proof mass changes a resonant wavelength of a micro-ring or micro-disk resonator formed by one or more waveguides.

In some embodiments, the one or more waveguides comprise two waveguides having evanescent-wave coupling therebetween.

In some embodiments, the one or more waveguides comprise a photonic ring or disk resonator having an inner ring waveguide and an outer ring waveguide.

In some embodiments, a method of forming a photonic inertial sensor is provided. The method includes providing a substrate having an insulation layer and a top layer on the insulation layer opposite the substrate; etching the top layer to form a proof mass for the photonic inertial sensor; etching at least a portion of the insulation layer underneath the proof mass to suspend the proof mass; and depositing a mass-increasing layer on the proof mass to thereby increase the mass of the proof mass.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of side views illustrating a simplified fabrication process on a silicon-on-insulator platform according to some embodiments.

FIG. 2 is a top view of the in-plane accelerometer design according to some embodiments.

FIG. 3 is a top view of the proposed in-plane device of FIG. 2.

FIGS. 4A-4B are electron micrographs of a fabricated in-plane accelerometer at 650 magnification (FIG. 4A) and at 2,500 magnification (FIG. 4B) according to some embodiments.

FIG. 5 is a graph of the normalized output power vs. relative displacement of the coupling gap and height according to some embodiments.

FIG. 6 illustrates schematics of the proposed out-of-plane device according to some embodiments.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

In some embodiments, the devices are fabricated on a platform compatible with low-loss optical propagation, on the same device layer as the optical waveguides. A widely used material stack is the silicon-on-insulator (SOI) platform, which is common in photonic integrated circuits. It can be simplified as ‘SOI platform’.

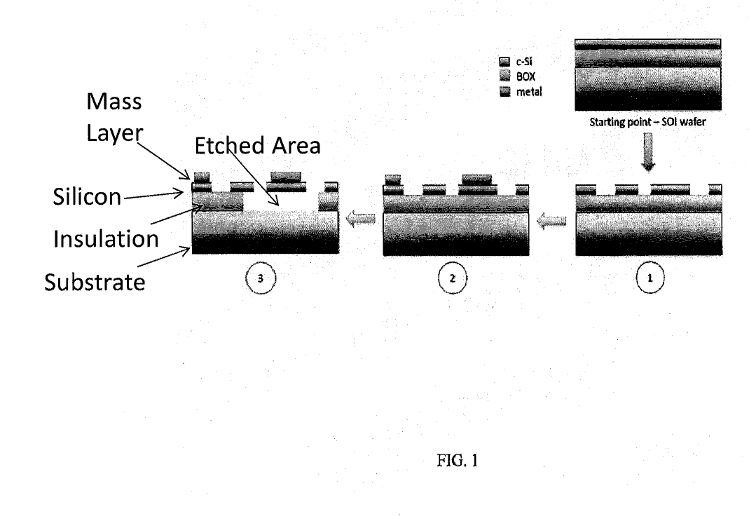

In some embodiments, a proof mass may be provided and a mass-increasing layer may be deposited on the proof mass to increase its mass and the sensitivity of the accelerometer. As illustrated in FIG. 1, the proof mass may be formed on a substrate having an insulating layer thereon and a silicon layer on the insulation layer opposite the substrate. The silicon layer (e.g., crystalline silicon) may be etched to form a silicon proof mass for a photonic inertial sensor. At least a portion of the insulation layer underneath the silicon proof mass may be etched to suspend the silicon proof mass, and a mass-increasing layer, such as metal, may be deposited on the silicon proof mass. In some embodiments, the silicon proof mass includes voids therein to permit etching of the insulation layer. Moreover, support springs may be formed in the silicon layer during the etching of the silicon layer to form both the silicon proof mass and springs to support the silicon proof mass once the underlying insulation layer is removed.

Fabrication processes are illustrated in FIG. 1. In the first step, the initial device layer of an SOI wafer is defined through the traditional top silicon layer patterning, for example, to form the silicon proof mass and support springs. In the second step, the metal layer is deposited on to the unetched silicon, which can also be performed post-fabrication. In the third step, the buried oxide is removed, allowing for the suspension of the movable MEMS parts. The metal layer deposition step may increase the silicon proof mass to increase sensitivity, for example, by enabling the proof mass to displace sufficiently to detect in-plane or out-of-plane acceleration.

### EXAMPLE 1

### Fabrication of In-Plane An Intensity-Based Optical MEMS Accelerometer

An in-plane Intensity-Based Optical MEMS Accelerometer is formed according to some embodiments. In the in-plane device, two waveguides are placed in close proximity and can be regarded as a variable directional coupler. As the inertial force acts on the device, the coupling ratio changes, therefore changing the optical output of the bus waveguide. Since the optical layer is very thin (submicron), the proof mass is to be covered with an additional high-density mass-increasing layer, such as metal (aluminum) or non-metal in order to increase its mass, and therefore, the sensitivity of the device.

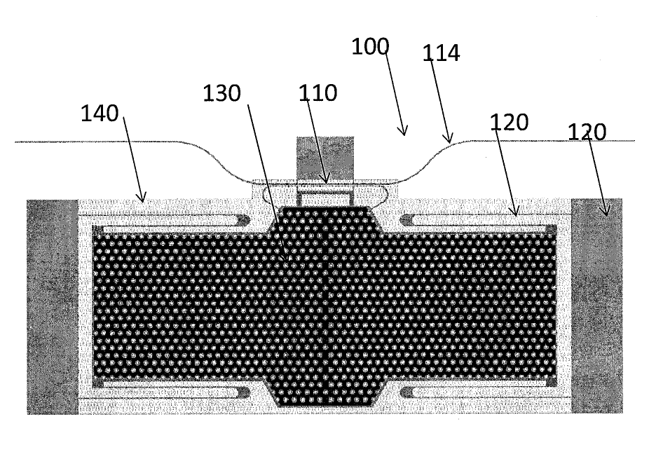

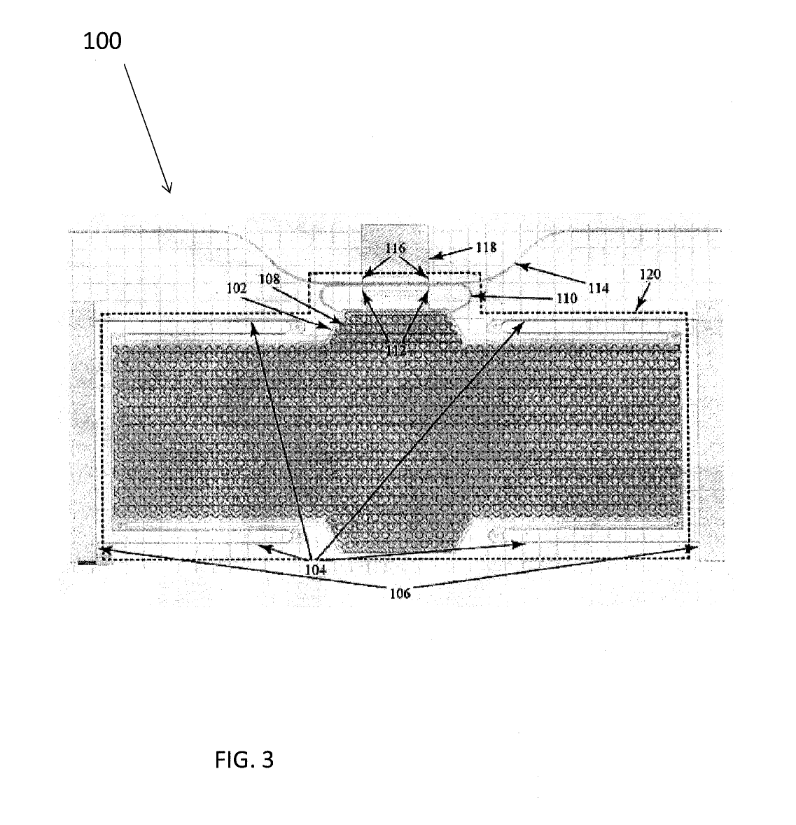

FIG. 2 further illustrates the fabricated in-plane MEMS accelerometer device 100. The top silicon layer 120, the metal layer 130 on top of a portion of the unetched silicon layer that forms the proof mass, and the buried oxide (insulation layer) removal region 140 are shown. The device 100 is designed on an SOI wafer, by patterning the top silicon layer (220 nm-thick in this case) and removing the buried oxide (2 μm-thick in this case), as described herein. The sensing element of the device is a silicon proof mass suspended on springs, which is described in greater detail with respect to FIG. 3. To increase the sensitivity of the device, in this example the proof mass is covered with metal (˜2.5 μm-thick aluminum). A 400 nm-wide waveguide 110 is fabricated on one side of the proof mass through supporting beams, coming in proximity with another similar waveguide 114 for forming a directional coupler. The two waveguides 110, 114 are parallel and have an initial lateral gap of 200 nm. The bus waveguide 114 is fixed at its ends, and only the waveguide 110, which is attached to the proof mass (shown as the metal layer 130), is allowed to displace (both in-plane and out-of-plane). When an inertial force acts on the device, the bus waveguide 114 remains stationary, while the other waveguide 110 moves together with the proof mass, therefore changing the height and gap between the waveguides. This height and gap determines the fraction of light that is coupled into the movable waveguide. The coupling coefficient depends on the proof mass displacement, thus inertial forces can be quantified by measuring the output power in the fixed waveguide 114. The accelerometer device 100 can be optimized for a broad range of input wavelengths by changing the cross-section dimensions of the waveguides, initial gap and the length of the coupling region.

Referring to FIG. 3, the sensing element of the device 100 is a silicon proof mass 102 suspended on springs 104, which are fixed to anchors 106. The proof mass 102 is perforated (e.g., includes apertures or voids therein) to enable under etching of the buried oxide. However, the perforations also reduce the mass/density of the proof mass 102. Since the thickness of the silicon layer of a standard SOI wafer is submicron, ranging normally between 50-340 nm for single-mode operation in the C-band (for wavelengths around 1550 nm), the weight of the resulting mass may not be enough to sense acceleration of 1 g, which is desired in most consumer electronics systems. In order to increase the sensitivity of the device, the proof mass 102 may be covered with additional material 108, such as high-density material like metal. Although any suitable high-density material may be used, in some embodiments, the additional material 108 is formed of a material that has a density higher than that of the silicon. The metal deposition can be incorporated into the fabrication process flow, or accomplished in post-fabrication stages such as focused ion beam (FIB)-assisted deposition. The photonic waveguide 110 is attached to one side of the proof mass 102 through supporting beams 112. The suspended bus waveguide 114 approaches the attached waveguide 110 forming an optical directional coupler. The waveguide 114 is fixed to an anchor 118 through supporting beams 116. The dashed border 120 encloses the region of the buried oxide removal.

The two waveguides 110 and 114 forming the directional coupler are designed to be parallel and to be separated by a specific initial gap. The bus waveguide 114 is fixed at its ends. When an inertial force acts upon the device, the bus waveguide 114 remains stationary, while the waveguide 110 moves together with the proof mass 102, therefore changing the gap between the waveguides 110, 114. As a result, a part of the input light in the bus waveguide 114 couples into the attached waveguide 110 and is lost. The coupling coefficient depends on the lateral proof mass displacement, thus inertial forces are determined by measuring the output power of the light at the bus waveguide 114.

### EXAMPLE 2

### Simulations of a Fabricated Intensity-Based Opto-MEMS Accelerometer

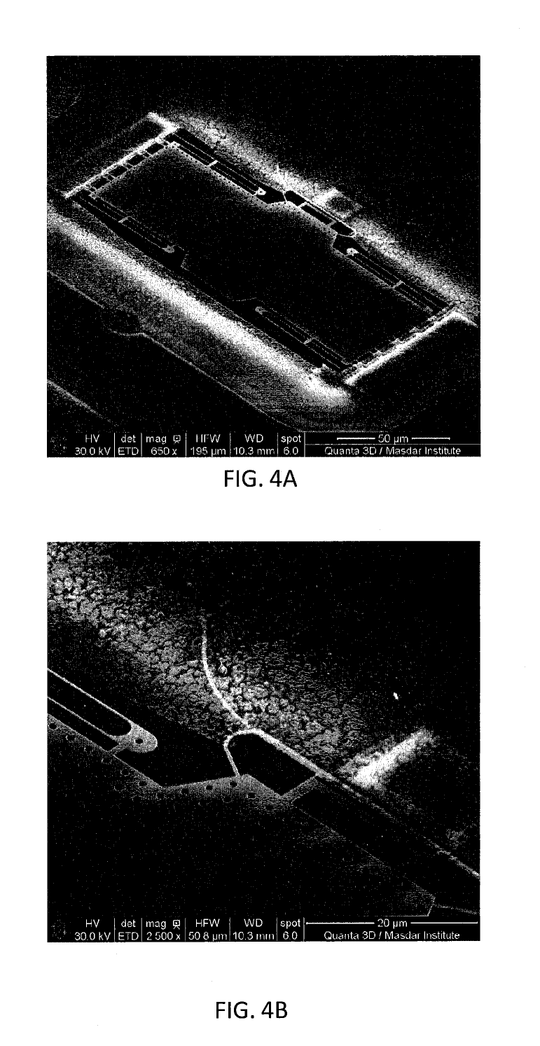

The footprint of the fabricated intensity-based optical MEMS accelerometer was 85 μm by 200 μm. FIG. 4 represents an electron micrograph of a fabricated structure obtained by an FEI Quanta 3D instrument at 30.0 kV. Two images were taken; one at 650 magnification and a second at 2,500 magnification. The first magnification shows the entire device, depicted in FIG. 2, the unit bar is 50 μm. The second higher magnification shows the gap coupling region where the optical waveguide runs parallel with the bus waveguide, the unit bar is 20 μm. The lateral length of the coupling region between the waveguides can be optimized depending upon other features of the device and its intended use.

The device can be optimized for a broad range of input wavelengths by changing the cross-section dimensions of the waveguides, the initial gap, and the length of the coupling region. One potential advantage according to some embodiments is that the device may not require wavelength scanning measurements. Furthermore, devices according to some embodiments may be combined with similar in-plane and out-of plane devices for a three-dimensional accelerometer completely integrated into the photonic layer, using the same material stack traditionally used for photonics integrated circuits.

The optical part of the accelerometer represents a variable symmetric directional coupler, where the changing parameter is the coupling gap. Therefore, the output power in the fixed waveguide is given by [1]:

$${P}_{out} = {P}_{i n} {cos}^{2} ( \frac{π L Δ n ( d )}{{λ}_{0}} ) , \qquad [ 1 ]$$

where Pᵢₙ is the input power in the bus waveguide, Pₒᵤₜ is the output power in the same waveguide, L the coupling region length, λ₀ the free-space wavelength, and Δn(d) the refractive index difference between the symmetric and anti-symmetric modes, which is a function of the coupling gap distance d. Numerical simulations were carried out to find Δn(d).

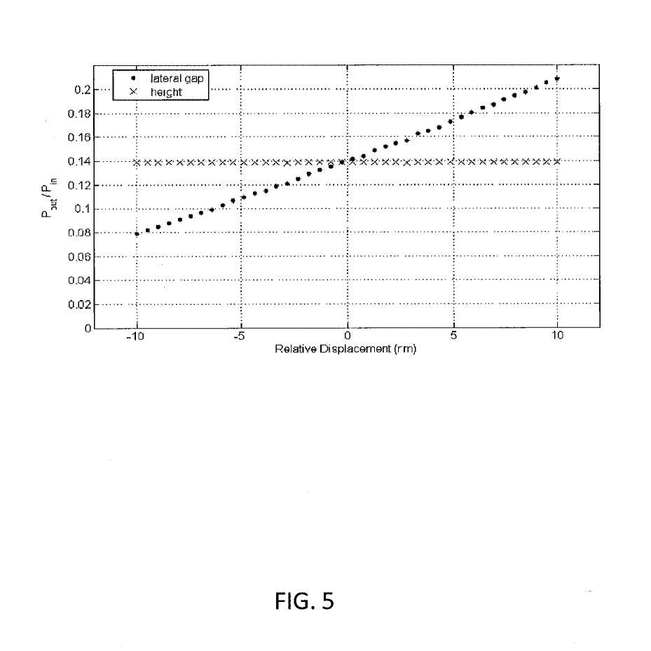

Mechanical FEM simulations of the accelerometer were performed under standard gravity. In FIG. 5, the normalized output power was plotted versus the coupling gap and height distance, corresponding to the acceleration range from −g to +g. These simulations showed that the output power varies linearly in the range of ±10 nm for the ±g acceleration range. The normalized output power is shown in FIG. 5, for L=20 μm and λ₀=1.55 μm. As seen from FIG. 5, for this specific design, the out-of-plane displacements have much less influence on the coupling ratio than the in-plane displacements. The optical mode simulations revealed that the power transfer coefficient depends on the lateral gap shift substantially stronger than on the vertical gap shift, resulting in higher selectivity of the accelerometer.

### EXAMPLE 3

### Out-of-Plane Resonant-Based Optical MEMS Accelerometer

In an out-of-plane accelerometer device, the device includes two coaxial rings implemented in the top silicon layer of the SOI wafer. The outer ring serves as a photonic ring resonator and is loaded with a bus waveguide for signal input/output. The inner ring (which could also be a disk) is suspended and is held by springs, which are fixed in the center of the ring, so that it can move respectively to the outer one. As the inner ring moves because of the inertial forces, the outer ring changes its resonant frequencies.

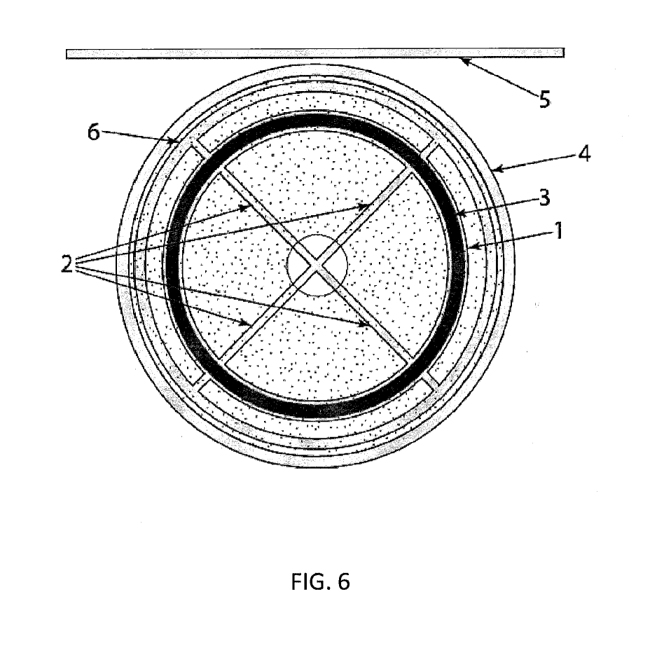

FIG. 6 further illustrates the out-of-plane MEMS accelerometer device. Referring to the drawings in FIG. 6, the sensing element of the device is a silicon proof mass 1 suspended on springs 2, which are fixed on the buried oxide in the center. The dotted area represents a region of etched buried oxide. The proof mass can be optionally covered with a metal layer 3. The metal layer 3 will increase the mass, and thus improve the sensitivity. The outer ring 4 with the waveguide 5 is a loaded photonic ring resonator. A smaller suspended coaxial ring 6 is attached to the proof mass 1. As inertial forces are applied in the out-of-plane direction, the inner ring 6 moves relative to the outer ring 4, causing effective refractive index change of the propagation mode in the outer ring 4, thus shifting the resonant frequency peaks. The frequency shift value depends on the displacement of the mass 1, and therefore, the force on the device can be measured.

As shown in FIG. 6, the solid light gray color represents the top silicon layer, the solid dark gray represents the metal layer on top of the proof mass, and the dotted area represents the region of buried oxide removal. The device is designed on an SOI wafer, by patterning the top silicon layer (220 nm-thick in this case) and removing the buried oxide (2 μm-thick in this case), as described herein. The sensing element of the device is a silicon proof mass 1 suspended on springs as described herein. To increase the sensitivity of the device, in this example, the proof mass 1 is covered with metal (˜2.5 μm-thick aluminum). The inner ring 6 is a 400 nm-wide waveguide inner ring and is fabricated on one side of the mass 1 through supporting beams, coming in proximity with the outer ring 4. The waveguides 4, 6 of the two rings are parallel and have an initial lateral gap of 200 nm. The outer ring 4 is coupled to a bus waveguide. Both the bus waveguide and the outer ring 4 are fixed, and only the inner ring 6 attached to the proof mass 1 is allowed to displace (out-of-plane). When an inertial force acts on the device, the outer ring 4 remains stationary, while the inner ring 6 moves together with the proof mass 1, therefore changing the height between the rings, i.e., into and out of the page. This height, which depends on the proof mass displacement, changes the resonant frequency of the outer ring. Thus out-of-plane inertial forces can be quantified by measuring the resonant frequency at the output fixed bus waveguide. The operating point (sensitivity, quality factor, free spectral range, etc.) of the accelerometer can be tuned by changing the cross-section dimensions of the waveguides, lateral gaps and the radii of the rings.

This out-of-plane device can be combined with in-plane accelerometers (such as those described above) for a full three-dimensional accelerometer system completely integrated into the photonic layer, using the same material stack traditionally used for photonics integrated circuits.

In some embodiments, a simplified, fully-integrated intensity-based opto-mechanical inertial sensor is provided that facilitates in-plane acceleration measurement incorporating a single wavelength source. The device can be optimized for a broad range of input wavelengths by changing the cross-section dimensions of the waveguides, initial gap, and the length of the coupling region.

In some embodiments, the intensity-based opto-MEMS accelerometer includes implementation on a silicon-on-insulator (SOI) platform and embedded in photonic integrated circuits to enable inertial sensing, without the requirement of wavelength tuning, or implementation as a standalone miniature device, connected to an optical network with a fiber. For continuous wave operation, broadband incoherent light source can be used, without the requirement for tunable laser sources or spectrometers.

In another embodiment, the proof mass is silicon and is suspended on springs. In accordance with another embodiment, the proof mass is covered by metal in order to increase its mass and therefore the sensitivity. The additional proof mass can be achieved by a variety of in-situ deposition techniques, such as but not limited to Focused Ion Beam (FIB)-assisted deposition, as well as by using additional layers (metallic or non-metallic) that are available in a full CMOS process compatible with commercial foundries. The concept of enabling the accelerometer in this thin platform by increasing the proof mass with additional materials can also be used in accelerometer configurations other than the ones described here.

In some embodiments, a photonic waveguide is fixed to the proof mass at two points that are placed in parallel to a suspended bus waveguide. The proximity of two guides, or gap, ranges from 25 nm to 500 nm, and, preferably, 150 nm to 250 nm. The coupling gap distance forms a directional coupler.

In some embodiments, the sensing mechanism is based on the strong dependence of the spatial coupling between waveguides with the coupling gap distance. Based on evanescent field coupling, the design acts as a variable directional coupler. The change in the coupling gap leads to a change in the power transfer ratio.

In some embodiments, placing two perpendicularly-placed accelerometer devices provides total in-plane inertial sensing while one accelerometer is unidirectional in plane.

In some embodiments, a fully-integrated out-of-plane accelerometer based on wavelength changes is provided, which when in combination with the two perpendicularly-placed in-plane accelerometers, provides a full three-dimensional inertial sensing.

The design of fully-integrated optical MEMS accelerometers and a method for increasing their sensitivity and reliability while reducing their size are detailed herein. The devices can be fabricated in any platform compatible with low-loss optical propagation and are described here on a silicon-on-insulator platform traditionally used for optical devices. Each device comprises a suspended movable proof mass with an attached photonic waveguide and a fixed suspended bus waveguide. All parts of the devices are defined in the same material layer (in this case silicon). Two accelerometers are presented: in-plane accelerometer based on intensity modulation, and an out-of-plane accelerometer based on resonant wavelength shift.

The optical MEMS accelerometers described herein can be included in a photonic integrated circuit to enable embedded inertial sensing, or implemented as standalone miniature devices connected to an optical network, for example, through optical fibers.

Any suitable materials may be used for the substrate, top silicon layer (and silicon components) and the insulating layer, as long as they are low-loss at the wavelengths of operation and satisfy the total internal reflection condition for waveguiding in the thin top layer. In some embodiments, the silicon layer comprises crystalline silicon. This top layer may also be formed by other materials (such as silicon nitride), as long as its index of refraction is higher than the one of the insulating layer. This also includes doped materials and gradient-index materials. The substrate may also be formed of silicon; however, glass or quartz may also be used. The insulating layer may be a buried oxide layer, such as silicon dioxide. Sapphire may also be used as an insulating layer. The mass-increasing material may be metal, such as aluminum, or any other materials (ideally high-density materials) that easily increase the mass of the silicon proof mass.

The foregoing is illustrative of the present invention and is not to be construed as limiting thereof. Although a few example embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of forming a photonic inertial sensor, the method comprising:
providing a substrate having an insulation layer and a silicon layer on the insulation layer opposite the substrate;
etching the silicon layer to form a silicon proof mass for the photonic inertial sensor;
etching at least a portion of the insulation layer underneath the silicon proof mass to suspend the silicon proof mass; and
depositing a mass-increasing layer on the silicon proof mass to thereby increase the mass of the silicon proof mass.

2. The method of claim 1, wherein the mass-increasing layer comprises metal.

3. The method of claim 2, wherein the metal comprises aluminum.

4. The method of claim 1, wherein depositing a mass-increasing layer on the silicon proof mass comprises Focused Ion Beam (FIB)-assisted deposition.

5. The method of claim 1, wherein etching the silicon layer to form a silicon proof mass for the photonic inertial sensor comprises forming a silicon proof mass comprising voids therein.

6. The method of claim 1, further comprising forming support springs that support the silicon proof mass when the silicon proof mass is suspended.

7. The method of claim 6, wherein the support springs comprise silicon from the silicon layer and wherein etching the silicon layer to form a silicon proof mass further comprises etching the silicon layer to form the support springs.

8. The method of claim 1, further comprising forming one or more waveguides on the silicon layer, the one or more waveguides being coupled to the silicon proof mass such that movement of the silicon proof mass changes an optical output of the one or more waveguides.

9. The method of claim 8, wherein movement of the silicon proof mass changes an intensity of light in the one or more waveguides.

10. The method of claim 8, wherein movement of the silicon proof mass changes a resonant wavelengths of a resonant device formed by one or more waveguides.

11. The method of claim 8, wherein the one or more waveguides comprise two waveguides having evanescent-wave coupling therebetween.

12. The method of claim 8, wherein the one or more waveguides comprise a photonic ring resonator having an inner ring waveguide and an outer ring waveguide.

13. A micro-opto-mechanical sensor device comprising:
a substrate;
a silicon proof mass on the substrate and supported by a plurality of support springs, the silicon proof mass being spaced apart from the substrate; and
one or more optical waveguides associated with the silicon proof mass such that movement of the silicon proof mass changes an optical output of the one or more optical waveguides,
wherein the silicon proof mass comprises a silicon layer and a mass-increasing layer thereon.

14. The device of claim 13, wherein the mass-increasing layer comprises metal.

15. The device of claim 14, wherein the metal comprises aluminum.

16. The device of claim 13, wherein the silicon proof mass comprises voids therein.

17. The device of claim 13, wherein the support springs each have first and second ends, the support springs being connected to the silicon proof mass at the first end and connected to an insulating layer at the second end.

18. The device of claim 17, wherein the support springs comprise silicon.

19. The device of claim 13, wherein movement of the silicon proof mass changes an intensity of light in one or more waveguides.

20. The device of claim 13, wherein movement of the silicon proof mass changes a resonant wavelength of a resonant device formed by one or more waveguides.

21. The device of claim 13, wherein the one or more waveguides comprise two waveguides having evanescent-wave coupling therebetween.

22. The device of claim 13, wherein the one or more waveguides comprise a photonic ring resonator having an inner ring waveguide and an outer ring waveguide.

23. A method of forming a photonic inertial sensor, the method comprising:
providing a substrate having an insulation layer and a first layer on the insulation layer opposite the substrate;
etching the first layer to form a proof mass for the photonic inertial sensor;
etching at least a portion of the insulation layer underneath the proof mass to suspend the proof mass; and
depositing a mass-increasing layer on the proof mass to thereby increase a mass of the proof mass.
